(19) United States
(12) Patent Application Publication
(10) Pub. No.: US 2026/0196094 A2
(43) Pub. Date: Jul. 9, 2026

(54) Parking Meter

(71) Applicants: James George Mackay, Frasers Mountain (CA); Darren Scott Cameron, New Glasgow (CA); Adrian Ignatius O'Neil, New Glasgow (CA); Gregory Emile Chauvin, Brookside (CA)

(72) Inventors: James George Mackay, Frasers Mountain (CA); Darren Scott Cameron, New Glasgow (CA); Adrian Ignatius O'Neil, New Glasgow (CA); Gregory Emile Chauvin, Brookside (CA)

(73) Assignee: J.J. MacKay Canada Limited, New Glasgow, NS (CA)

(21) Appl. No.: 19/221,888

(22) Filed: May 29, 2025

Related U.S. Application Data
(60) Provisional application No. 63/657,162, filed on Jun. 7, 2024.

(30) Foreign Application Priority Data
Oct. 21, 2024 (CA) 3249943

(51) Int. Cl. G07F 17/24

(52) U.S. Cl. CPC G07F 17/248

(57) ABSTRACT

A parking meter is provided that has a parking meter mechanism and an extruded tubular base secured to an existing pole. The extruded tubular base encloses a coin canister that may be accessed through either an opening in the base of the parking meter mechanism or a door opening in the extruded tubular base. The extruded tubular base may be secured to the existing pole by an upper ring and a lower ring. One or more lights may be arranged down the sides of the extruded tubular structure to convey information to users or parking enforcement personnel.

### RELATED APPLICATIONS

The current application claims priority to U.S. Patent Application No. 63/657,162 filed Jun. 7, 2024 and titled “Parking Meter”, and Canadian Patent Application No. 3,249,943 filed Oct. 21, 2024 and titled “Parking Meter”.

### TECHNICAL FIELD

The current disclosure relates to parking meters and in particular to pole mounted parking meters.

### BACKGROUND

Parking meters, such as single space parking meters, are often mounted to poles in the vicinity of a parking spot, or parking spots, being metered. The poles are securely installed into, for example, a sidewalk, walkway, road, parking lot, etc. A coin vault housing is typically secured to the top of a pole and a parking meter secured to, or within, an exterior meter housing that is mounted to the coin vault housing. A coin vault or coin canister can be securely held within the coin vault housing and secured by an exterior door that can be locked. Coins inserted into the parking meter can pass through a hole or opening in the meter housing and into the coin vault within the coin vault housing. The coin vault housing door can be opened and the coin vault extracted from the housing during coin collection operations. With pole mounted parking meters, the pole, as well as the coin vault housing are exposed to the elements and environment. The exposed coin vault housing and coin vault housing door can provide a point of focus for vandalism and attacks attempting to steal the coin vaults.

New parking meter mechanisms can be designed that can be secured to, on, or within, existing housings such as the meter housing or the coin vault housing. Adapting new meter mechanisms to work with existing housings or existing infrastructure such as securely installed poles at parking locations can reduce the cost required to upgrade or replace existing parking meters, including meter mechanisms with new mechanisms.

An additional, alternative and/or improved parking meter is desirable.

### BRIEF DESCRIPTION OF THE DRAWINGS

Further features and advantages of the present disclosure will become apparent from the following detailed description, taken in combination with the appended drawings, in which:

FIGS. 1A, 1B, 1C depict front, side and back line drawings of an embodiment of a parking meter;

FIG. 2 depicts an exploded view of portions of the parking meter of FIGS. 1A-1C;

FIG. 3 depicts details of a concealed coin vault;

FIG. 4 depicts a line drawing of a further embodiment of the parking meter showing internal components;

FIGS. 5A, 5B depict front and side views, respectively, of line drawings of a further embodiment of a parking meter;

FIGS. 6A, 6B depict front and side views, respectively, of line drawings of a further embodiment of a parking meter;

FIGS. 7A, 7B depict front and side views, respectively, of line drawings of a further embodiment of a parking meter with a front vault door in a closed position;

FIGS. 7C, 7D depict front and side views, respectively, of line drawings of the parking meter of FIGS. 7A and 7B with the front vault door in an open position; and

FIG. 8 depicts details of the front vault door.

### DETAILED DESCRIPTION

In accordance with the present disclosure there is provided a parking meter comprising: a parking meter mechanism having a base; and an extruded tubular base secured to an existing pole at a parking meter location, the extruded tubular base extending from adjacent the ground to the base of the parking meter mechanism, wherein the parking meter mechanism is secured to the extruded tubular base.

In a further embodiment of the parking meter, the extruded tubular base encloses a coin canister.

In a further embodiment of the parking meter, the coin canister is accessed through an opening in the base of the parking meter mechanism.

In a further embodiment of the parking meter, the parking meter mechanism is moveable between a maintenance position in which the opening is exposed to allow access to the coin canister and an operating position in which the opening is covered.

In a further embodiment of the parking meter, the coin canister is accessed through a door opening in the extruded tubular base.

In a further embodiment of the parking meter, a lockable door secures access to the coin canister through the opening in the extruded tubular base.

In a further embodiment of the parking meter, the lockable door is secured to a frame structure secured within an interior of the extruded tubular base.

In a further embodiment of the parking meter, the frame structure comprises a pair of channels that engage with edges of the door opening in the extruded tubular base.

In a further embodiment of the parking meter, the coin canister is an elongated coin canister.

In a further embodiment of the parking meter, the extruded tubular base is secured to the existing pole by an upper ring and a lower ring.

In a further embodiment of the parking meter, each of the upper ring and lower ring are secured to both the existing pole and the extruded tubular base.

In a further embodiment of the parking meter, a solar panel is provided on at least a portion of an exterior surface of the extruded tubular base.

In a further embodiment of the parking meter, an interior volume within the extruded tubular base encloses one or more batteries.

In a further embodiment of the parking meter, the one or more batteries comprise rechargeable batteries.

In a further embodiment of the parking meter, the one or more batteries are mounted on a battery shelf.

In a further embodiment of the parking meter, the extruded tubular structure comprises one more lights.

In a further embodiment of the parking meter, the one or more lights comprise one or more light tubes, bubble rods or light strips.

In a further embodiment of the parking meter, the one or more lights are arranged down the sides of the extruded tubular structure.

In a further embodiment of the parking meter, the lights are controllable to convey information to users or parking enforcement personnel.

In a further embodiment of the parking meter, the extruded tubular base displays information or advertisements.

In a further embodiment of the parking meter, the extruded tubular base is non-cylindrical.

A parking meter can be mounted to a pole secured at a metering location with a tubular extrusion surrounding the pole. The tubular extrusion provides a protected interior space within which a coin vault or coin canister can be concealed. As described further below, the coin vault can be removed through a base of the parking meter mechanism. The base may have a hole sized to allow the coin vault to be removed when the parking meter mechanism is moved to a maintenance or access position. When the parking meter mechanism is secured in an operating position, the access hole for the coin vault is covered and so the coin vault is secured within the tubular extrusion. Further, the coin vault and how to access it are completely covered by the parking meter when in the operating position. Concealing the coin vault, and the access to the coin vault can help discourage vandalism and/or theft attempts. Surrounding the mounting pole with the tubular extrusion can make traditional attacks, such as vault jacking and/or pole cutting, more difficult. Further, eliminating the typical coin vault housing having an externally accessible coin vault door can provide greater flexibility for the design of the parking meter.

The tubular extrusion surrounding the pole can provide a large internal volume which may be used for example to provide a large coin vault. Further, the interior volume could be used to provide additional or other parking meter components or parts, such as larger coin vaults, battery packs, vehicle occupancy sensors, etc. While the interior volume may provide additional volume for meter components, the exterior surface of the tubular extrusion can be used for various purposes including for example displaying information, advertisements, providing solar panels, LED lights, etc.

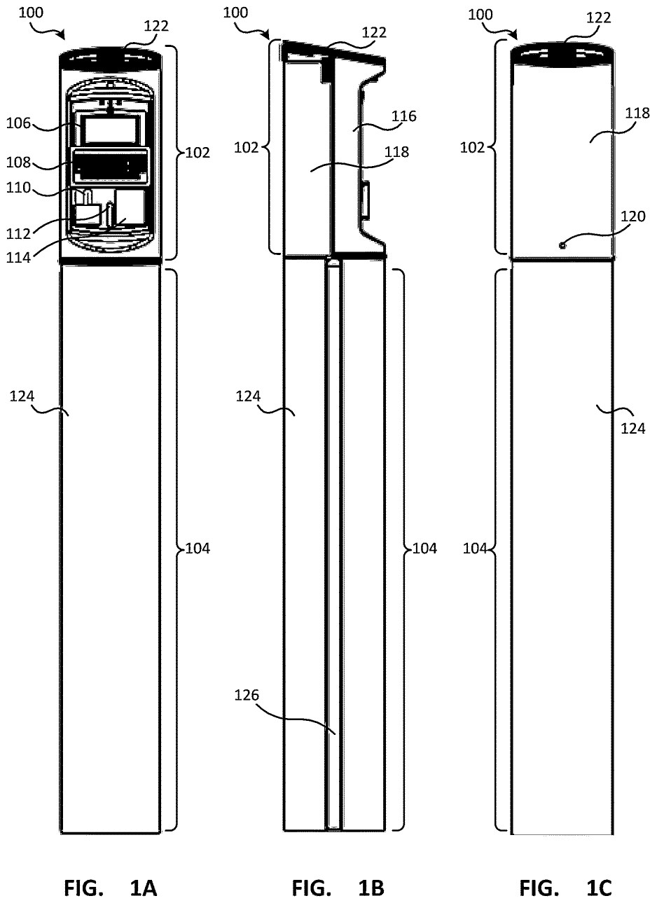

FIGS. 1A, 1B, 1C depict front, side and rear views of a parking meter with a tubular extruded pole mount. The parking meter 100 comprises the parking meter mechanism 102 and a lower mounting structure 104. The parking meter 100 comprises various components including a display 106 that may be used to display parking meter related information to users, including payment instructions, status information, and other information. The parking meter may further include one or more input devices 108 allowing a user to interact with the parking meter, for example in order to select an amount of parking time to purchase, or other information. The input device 108 is depicted as an alpha-numeric keypad that can allow a user to input information such as license plate information, selection of parking options, payment codes, PIN numbers, email addresses, phone numbers etc. Although depicted as an alpha-numeric keypad, the input devices may be provided simply as one or more individual buttons. Further, although the display 106 and input device 108 are depicted as separate devices, it is possible to combine the devices together as a touch screen display. In addition to the user interface components providing display and input devices, the parking meter may further include a number of payment devices for accepting payment from the user for the parking time. The payment devices may include a card reader 110 for reading account or payment information from a magnetic stripe card or chip based card. The payment devices may further include a coin slot 112 and coin discriminator within the parking meter mechanism for determining denominations of coins inserted into the coin slot and before entering the coin vault. Further, the payment devices may include a tap reader, or contactless reader for reading account or payment information wirelessly.

The meter components are mounted on or in the parking meter housing which is provided by one or more external housings providing protection to the internal components from the environment, vandalism and attacks. The external housing may be provided in various ways; however as depicted in FIGS. 1A-1C, the external housing may be provided by two, or more, external housings that can be secured together. As depicted, the external housing may comprise a front housing 116 and a rear housing 118. The rear housing 118 has a cylindrical, or half-cylindrical, shape, with rails at the edges allowing the front housing 116 to slide vertically up and down. The rear housing 118 may be secured at the meter location, for example by securing it directly or indirectly to the pole, and/or the tubular extruded structure surrounding the pole. With the rear housing 118 secured at the parking meter location, the front housing 116 can be slid all the way down the rails of the rear housing and secured in place, for example by way of a keyed lock 120, or other locking mechanism, that secures the front housing to the rear housing.

When unlocked from the rear housing, the front housing may be slid up the rails of the rear housing. The front housing may be positioned at various heights along the rear housing, for example using releasable latches, notches in the rails or other similar structures, in order to access one or more components within the meter as well as at least partially exposing an access opening in the parking meter through which the coin vault can be retrieved. The front housing, and any components attached to the front housing can be raised to one or more positions on the rear housing, or fully removed from the rear housing.

While the above has described one particular implementation of the external housing and how the housing can be moved between a secured operating position and one or more raised maintenance and/or removal positions, in which access to a coin vault arranged within the tubular extrusion is possible, it will be apparent that a wide range of housings are possible that can be securely locked at the parking meter location and unlocked to be at least partially removed in order to access the coin vault.

The external housing may have one or more locations for mounting or housing solar panels 122. The solar panels may be used to charge one or more batteries of the parking meter powering the parking meter. It will be appreciated that the solar panels may charge the batteries while other meter components are discharging the batteries.

A tubular extruded structure 124 is secured around the pole or post at the parking meter location. The tubular structure 124 may have one more light tubes 126, or LED light strips, bubble rods or other lighting, arranged down sides of the tubular extrusion 124. The lighting may be controlled in order convey various information to users and/or parking enforcement personnel as well as to efficiently manage the lighting power being drawn from internal batteries.

The lower mounting structure comprises a tubular extrusion 124 surrounding a pole and other mounting components (not visible in FIGS. 1A-1C). The tubular extrusion may be secured, directly or indirectly, to the pole mounted at the parking location. The tubular extrusion may be made from metal aluminum, stainless steel, high strength polymers or plastics, etc. The parking meter may use a round, tubular shaped aluminum extrusion base, together with one or more matching retaining rings and base skirt that are secured to a pole. The retaining rings, such as an upper ring and a lower ring, may be secured to both the existing pole and the extruded tubular base. The outer diameter of the base can match the outer diameter of the base plate/rear cover of existing parking meters, such as the mkBeacon meter of Mackay Meters. The retaining rings may also serve as overlapping retainers of flexible solar panels wrapped around the exterior tubular extrusion. The overlapping retaining ring will hide panel edges reducing vandalism attacks and pry points on the solar panel

Different parking meter mechanisms having different base profile shapes may be used by adapting a top of the tubular extrusion to transition from the profile of the bottom of the parking meter mechanism to that of the extruded tube. While the extruded tube may be formed to transition to the bottom of the parking meter, a separate transition component can be mounted between the top of the tubular extrusion and the bottom of the parking meter. Although depicted as a round tube, it is possible to use other shapes for the extruded base tube. Such other shapes may match the base profile shapes of other/different parking meter mechanisms, or may include a transition between the profiles of the extruded tube and the bottom of the parking meter. The transition at the base of the extrusion may also allow for a larger rechargeable battery storage area. The extruded tubular base fits over and securely attaches to an existing meter pole already anchored at a physical location, such as into a concrete sidewalk, with no pole attachment points visible. Without attachment points visible, it can reduce vandal attacks since points of attack are not readily apparent. An upper portion of the tubular base also acts as a vault, securing a coin canister or vault within the meter.

With the additional volume provided by the extruded tubular base, the coin canister may be a high capacity extended length coin canister. There is no vault door lock or opening visible on the exterior of the base, which can reduce vandalism and/or theft as it is not obvious that there is a coin vault in the parking meter or how to access it. Further, eliminating the external coin vault door also reduces the number of openings required within the exterior housing, each of which can provide points of attack that may require reinforcing against attacks.

Coin collection can be carried out by unlocking and raising/moving the parking meter mechanism in order to expose a coin vault door. The parking meter mechanism may be unlocked and raised to its upper maintenance position, which exposes an opening in the base plate with a coin vault door. The vault door can then be unlocked and opened. With the vault door in the parking meter base opened, the coin canister can be removed and/or exchanged.

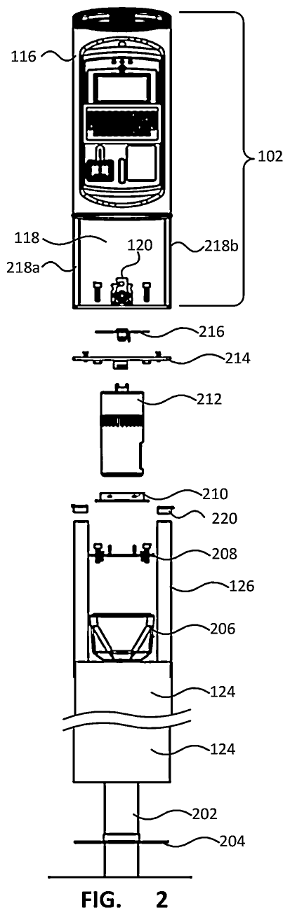

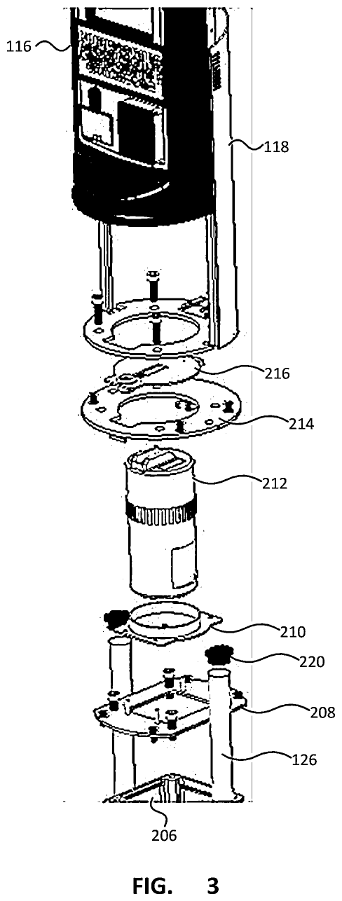

FIG. 2 depicts a partially exploded view of a parking meter with concealed coin vault. FIG. 3 depicts details of the partially exploded view of the parking meter of FIG. 2. FIGS. 2 and 3 depict the internal mounting components for securing the extruded tubular structure to the pole as well as the extended coin vault and parking meter. When installing the parking meter to a pole 202 at a parking meter location, a lower pole collar 204 can be slid over the pole 202. The short base vault mount 206 can be installed into the top of the street pole. The short base vault mount provides a secure mounting structure for mounting the vault components to the existing pole 202. It will be appreciated that the short base vault mount may be omitted and the coin vault support mounted to the pole without intervening structures or with alternative intervening structures. An intermediary support plate 208 can be secured onto the short base vault mount via bolts. The intermediary support plate 208 may also be secured to the tubular extruded structure 124 using screws or bolts. A coin can mounting plate 210 can be installed to the intermediary support plate 208, for example using nuts to secure it in place. The coin can mounting plate 210 allows a coin vault 212 to be securely and removably held within the extruded tubular structure 124. As depicted the coin can mounting plate 210 has a ring defining a pocket into which the coin vault can be received. The coin vault 212 can be installed onto the coin can mounting plate 210. One or more alignment pins may be used to ensure the coin vault is properly oriented in the parking meter to allow coins to be received within a coin slot opening of the coin vault. A top mounting plate 214 is secured to the top of the extruded tubular structure 124. The top mounting plate 214 comprises an opening through which the coin vault 212 can be extracted. The opening in the top mounting plate 214 may be covered by a lockable door 216 that can provide additional protection against theft of the coin vault. With the lockable door locked in a closed position, the coin vault cannot be extracted through the opening.

The parking meter assembly can be mounted to the top mounting plate 214. In particular the rear housing 118 of the parking meter may be secured to the top mounting plate, for example using bolts. The bottom of the rear housing 118 has an opening in it in that aligns with the opening in the top mounting plate 214 when the rear housing is secured in place in order to allow the coin vault door to be opened. As depicted in FIG. 2, the front housing 116 of the parking meter can be raised on rails 218a, 218b into a maintenance position, or possibly completely off of the rails of the rear housing. In the raised position, or when removed, the front housing and attached components are out of the way of the coin vault opening and so the coin vault can be extracted, the coins removed and the coin vault replaced. When the front housing 116 is lowered into an operating position and locked in place with lock 120, the coin vault and the opening to retrieve it are completely hidden from view and the coin vault cannot be extracted from the parking meter. With the parking meter assembly locked in place, the coin vault door is concealed and protected from unauthorized access. In the case of a meter configured to be cashless payments only, e.g., card payments only, the hidden vault area can instead be utilized as a storage space for a second rechargeable battery pack.

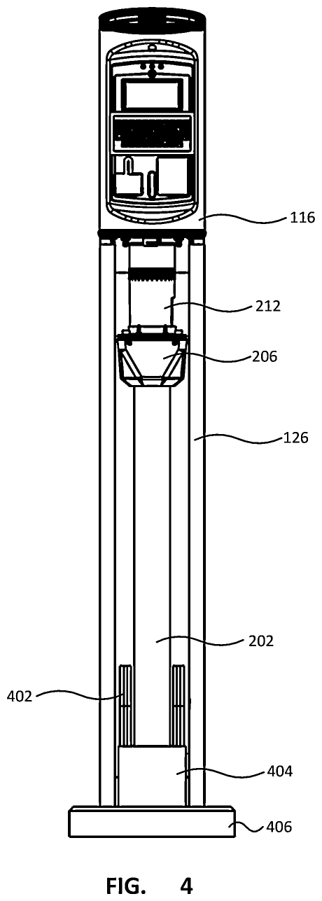

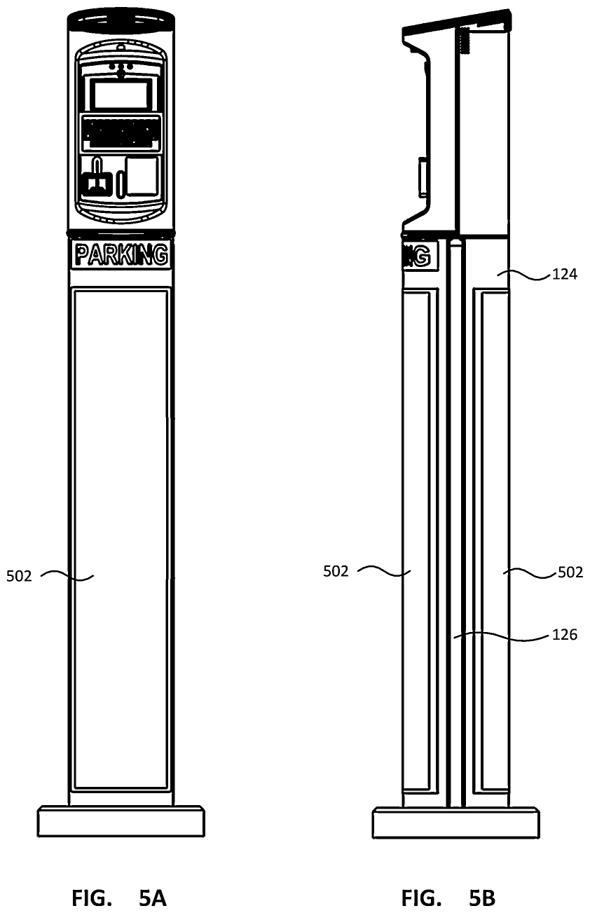

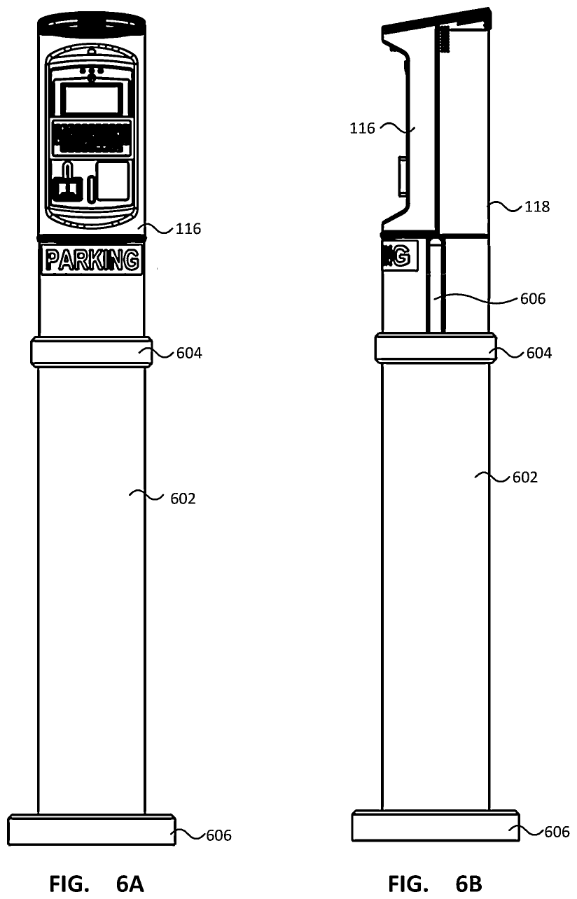

LED lights of one or multiple colours can be installed into light tubes 126 that can run down the sides of the extruded tubular structure. The light tubes 126 may be formed from acrylic and help to diffuse the light from the LEDs down along the length of the tubes. LED caps 220 installed on the tops of the tubes. The caps can provide a wiring harness for the LEDs that allow cabling to for powering and controlling the LED lights to be attached. The LED lights and light tubes can be used to convey information to individuals. For example, the colour of the light may convey status information such as if the parking meter time is expired, if the parking spot is occupied or free, if there are any errors in the parking meter, among other possible status information. While described as an arrangement of a light tube with LEDs located at the top, it is possible to use LED strip lights, bubble rods or similar to provide controllable lighting along the sides of the parking meter. Further, while described as being provided down the sides of the parking meter, other lighting arrangements may be provided such as one or more rings located around the tubular structure. The extruded base may support the bottom of the light pipes extending down at least a portion of one or more sides of the tubular base. As depicted in FIGS. 4 and 5B, the light tubes may extend down a substantial length of the tubular base towards the ground or skirt/base. Alternatively, as depicted in FIGS. 6A and 6B, the light tubes may extend only partially down the side of the tubular base, or other structure mounted to the base. The lights can be used to communicate various information, such as the operational status of the parking meter, an indication of an amount of time remaining, whether a metered parking spot is free or occupied, whether payment for parking is currently required, etc. The lights may be particularly useful for evening/nighttime use, although they may be used at anytime. Multi-color super-bright LEDs mounted at the top of each light pipe and connected to and controlled by the meter provide light pipe illumination. Other types of lighting such as LED light strips, bubble rods, etc. may be used. The lights can be used to draw attention to parking meter locations, indicate paid or operational status to enforcement officers or maintenance staff, or provide decorative alternating colors or brightness, among other features.

The light tubes 126 may also be alternatively used to enclose and secure a string of standard size cylindrical batteries electrically connected together in a series, parallel or series parallel circuit arrangement. These batteries may be a rechargeable battery type capable of being charged by one or more parking meter solar panels. Alternatively, the batteries arranged into these light tubes may be common, low cost, non-rechargeable alkaline or similar type. The light tubes 126 may support both lighting as well as cylindrical batteries through the use of thin LED light strips or thin formed acrylic diffusing light pipes or similar devices mounted along the exterior length of the string of electrically connected cylindrical batteries. An outer protective diffused plastic tube may be used to enclose the entire lighting and battery assembly such that one such light and battery assembly may be installed from the top and slid into the extrusion opening in each side of the tubular base. Electrical connections for each light and battery assembly may be provided at each end of the light and battery assembly to allow each to be connected to the parking meter which may then control the lighting. In addition, where rechargeable type batteries are used in each assembly, the rechargeable batteries can be electrically connected to the parking meter components, including solar panels for recharging the batteries.

The parking meter may use a round, tubular shaped aluminum extrusion base, with matching retaining rings and skirt that is secured to a pole. The outer diameter of the base can match the outer diameter of the base plate and/or rear cover of existing parking meters, such as the mkBeacon meter of Mackay Meters. Different parking meter mechanisms having different base profile shapes may be used with the mounting location adapted to transition from the profile of the parking meter mechanism to that of the extruded tube. Alternatively, the shape of the tubular aluminum extrusion may be changed to more closely match the shape of the parking meter mechanism. For example, although depicted as a round tube, it is possible to use other shapes such as a rectangular tube for the extruded base tube. Such other shapes may match the base profile shapes of other/different parking meter mechanisms. The extruded tubular base fits over and securely attaches to an existing meter pole already anchored at a physical location, such as into a concrete sidewalk, with no pole attachment points visible. Without attachment points visible, it can reduce vandal attacks since points of attack are not readily apparent. An upper portion of the tubular base also acts as a vault, securing a coin canister or vault within the meter.

With the additional volume provided by the extruded tubular base, the coin canister may be a high capacity extended length coin canister. The vault door lock or opening may be hidden and so is not visible on the exterior of the base, which can reduce vandalism and/or theft as it is not obvious that there is a coin vault in the parking meter or how to access it. Further, eliminating the external coin vault door may also reduce the number of openings required within the exterior housing, each of which can provide points of attack that may require reinforcing against attacks.

Coin collection can be carried out by unlocking and raising/moving the parking meter mechanism in order to expose a coin vault door. The parking meter mechanism may be unlocked and raised to its upper maintenance position, which can expose an opening in the base plate with a coin vault door. The vault door can then be unlocked and opened. With the vault door in the parking meter base opened, the coin canister can be removed and/or exchanged.

As depicted in FIG. 4 the space between the inside of the aluminum extrusion and the outer wall of the existing meter pole provides significant storage space, which may be used, for example, to provide the extended height coin canister 212. Further, the space may be used to house rechargeable batteries 402. The rechargeable batteries 402 may sit on a base 404 located at the ground level, possibly on a lower mounting ring 406 secured around the tubular base on the ground. The rechargeable batteries can be electrically connected to the parking meter components, including solar panels for recharging the batteries.

FIG. 5 depicts a parking meter with flexible solar panels wrapped around a tubular base. As described above, the tubular base can provide an interior volume that can be used to house various components such as rechargeable batteries. In addition to the interior volume, the tubular base also provides an external surface which may be used for various purposes. For example, advertisements or similar displays can be applied to the exterior surface of the tubular base. Further, flexible or molded solar panels 502 can mounted to the exterior surface of the tubular structure 124. Alternatively, if the solar panels provide a rigid structure that is sufficiently resistant to vandalism attacks, the solar panels 502 themselves may provide a portion of the tubular structure. The solar panels may be electrically connected to the rechargeable batteries, whether internal to the parking meter or within the interior of the tubular base, by way of a solar controller circuit. The solar controller may be housed within the tubular base or within the parking meter mechanism secured to the tubular base. The solar controller may be capable of optimizing and managing the power available from one or more solar panels mounted to the exterior of the tubular extrusion base. The solar cells, when present, may supplement the meter's power supply. For example, the solar cells may supplement a solar charged battery pack of the meter, as well as extend operational life for the meter and additional power needs of the light pipes.

The flexible solar panels may be tightly wrapped, or otherwise formed, around the outer wall of the extruded base and can provide significant solar charge capacity for the rechargeable batteries. Front and back solar panels may be provided with the light tubes extending down between the front and back solar panels as depicted in FIGS. 5A, 5B.

FIGS. 6A and 6B depict a further parking meter with flexible solar panels. Similar to the parking meter described above with reference to FIGS. 5A and 5B, the parking meter 600 includes a flexible solar panel. However, in contrast to the parking meter 500, which has a pair of solar panels each extending around half of the tubular base between the light tubes, the parking meter 600 may include a solar panel 602, or panels, that extend completely, or substantially, around the tubular base. The solar panel 602, or panels, may be secured by an upper mounting ring 604 and a lower mounting ring 606. In addition to securing a top of the solar panels, the upper mounting ring 604 may also support a bottom of the light tubes 606, if present. Alternatively, the light tubes may extend from the upper mounting ring 604 to the lower mounting ring 606. The portion of the tubular housing above the upper mounting ring 604, which may not have a solar panel may be used as a location for securing labels, information, branding, etc.

The above has described various embodiments of a parking meter with an extruded tubular base that allows access to a coin vault through an opening that is covered by the parking meter mechanism when it is locked in the operating position. As described further below, it is possible to provide the extruded tubular base with a front access door or panel in order to be able to access the coin vault even if the parking meter mechanism remains locked in the operating position.

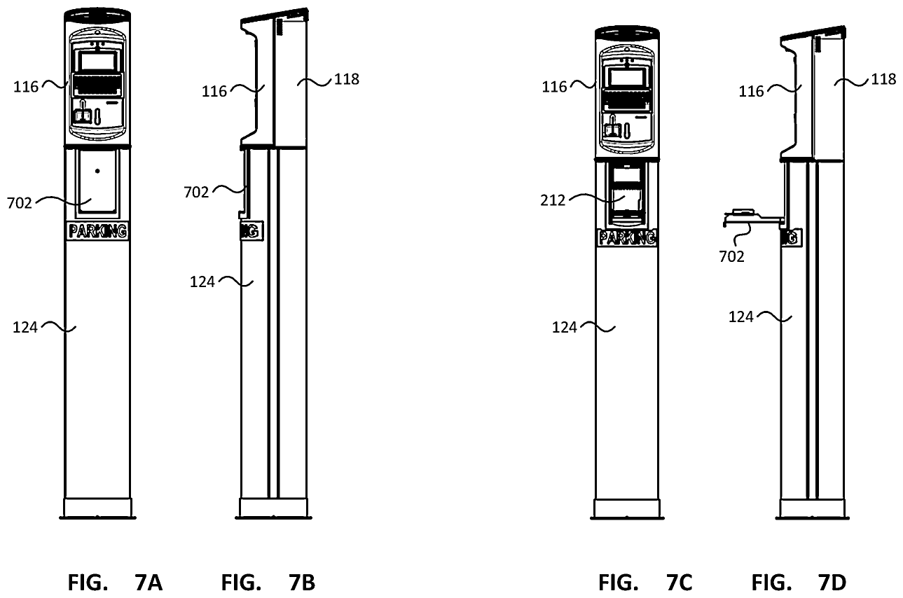

FIGS. 7A, 7B depict front and side views, respectively, of line drawings of a further embodiment of a parking meter with a front vault door in a closed position. FIGS. 7C, 7D depict front and side views, respectively, of line drawings of the parking meter of FIGS. 7A and 7B with the front vault door in an open position. In contrast to the embodiments described above, in which the opening for accessing the coin canister is covered by the parking meter mechanism when secured in the operating position, in the current embodiment the coin canister can be retrieved through an opening in the extruded tubular housing. As depicted, the extruded tubular housing 124 includes a cutout within which a door or access cover 702 is located. The door 702 may include a lock for securing the door in a closed position as depicted in FIGS. 7A, 7B. When unlocked, the door 702 may be opened as depicted in FIGS. 7C, 7D. While the door 702 is depicted as being hinged downward, it will be appreciated that the door may open to the top or side. Additionally, or alternatively, the door, once unlocked, could be removed from the parking meter structure. As can be most clearly seen in FIG. 7C, once the door is opened, the coin canister 212 can be removed from the interior of the parking meter structure.

The coin canister can be held within a framework secured within the tubular extrusion 124. The framework holding the canister can also provide an internal structure to which the door can be mounted as well as securing the locking mechanism.

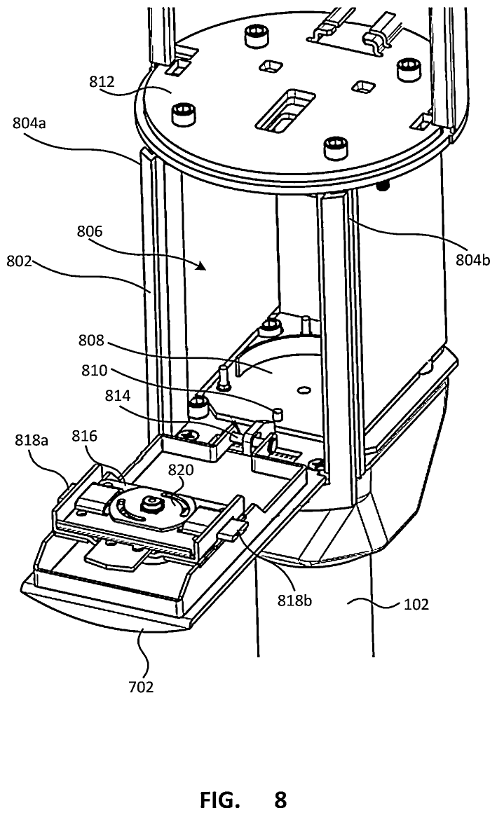

FIG. 8 depicts details of the front vault door and interior space of the extruded tubular housing. As can be seen in FIG. 8, the interior space of the extruded tubular housing allows a rectangular frame 802 to be mounted to the pole 102, either directly or through one or more intervening structures. The frame 802 may have channels 804a, 804b, or other cooperating features, that can engage with an edge of the extruded tubular housing which can have an opening cut into it. During assembly, once the extruded tubular housing is secured in place, the frame 802 can be slid into place with the channels 804a, 804b sliding over and securely capturing the edges of the rectangular opening in the extruded tubular housing. The channels allow the frame and extruded tubular housing to be securely connected together without requiring welding the components together. Since the two components can be attached without welding or other adhesives, it is possible to replace the frame in the field if it becomes damaged, for example due to vandalism.

The frame 802 may provide an enclosure 806 in which the coin canister can be held. The enclosure 806 may be closed on the sides as depicted, or may be open. The closed sides may provide additional strength to the frame. A bottom of the enclosure has a space 808 for receiving the coin canister (not shown). To ensure the coin canister is in the correct orientation to allow coins to enter the canister from the parking meter, one or more alignment features can be provided, such as pins 810 that cooperate with one or more corresponding features on the coin canister to ensure the coin canister can only be inserted in the correct orientation.

A bottom plate 812 of the parking meter caps off the top of the door opening that is cut out of extruded tubular base, preventing any upward vertical movement of the vault door frame once the parking meter is secured to the tubular base. A vault door 702 can be hinged to the frame by a hinge pin 814. The vault door may be made from heavy gauge stainless steel or other materials that provide sufficient strength against attacks. The hinge pin securing the door 702 to the frame 802 is not visible when the vault door 702 is in the closed and locked position. The vault door may have internal stiffening ribs welded in place or otherwise formed with the door.

The door may include a locking mechanism 816 for securing the door in place in the locked position, and allowing the door to open or be removed when unlocked. The locking mechanism may comprise a two-point locking assembly. This design uses a pair of sliding bars 818a, 818b that slide in or out to unlock or lock the door. When slid, the bars 818a, 818b can engage with stationary features on the frame to secure the door in place. A rotating plate 820 can be used to translate rotational movement of a keyed lock into the sliding motion of the bars. The keyed lock may use existing high security keyed locks. The keyed lock may have electronic functionality that allows the lock to be electronically operated or the keyed lock may be replaced with an electronic lock that does not have keys.

It will be appreciated by one of ordinary skill in the art that the system and components shown in FIGS. 1-8D may include components and/or steps not shown in the drawings. For simplicity and clarity of the illustration, elements in the figures are not necessarily to scale, are only schematic and are non-limiting of the elements and structures. It will be apparent to persons skilled in the art that a number of variations and modifications can be made without departing from the scope of the invention as defined in the claims.

Although certain components and steps have been described, it is contemplated that individually described components, as well as steps, may be combined together into fewer components or steps or the steps may be performed sequentially, non-sequentially or concurrently. One or more features, components, and/or elements may be described with reference to a particular embodiment. Such features, components and/or elements can be incorporated into and/or combined with other embodiments. Further, although described above as occurring in a particular order, one of ordinary skill in the art having regard to the current teachings will appreciate that the particular order of certain steps relative to other steps may be changed. Similarly, individual components or steps may be provided by a plurality of components or steps. One of ordinary skill in the art having regard to the current teachings will appreciate that the components and processes described herein may be provided by various combinations of software, firmware and/or hardware, other than the specific implementations described herein as illustrative examples.

The techniques of various embodiments may be implemented using software, hardware and/or a combination of software and hardware. Various embodiments are directed to apparatus, e.g. a node which may be used in a communications system or data storage system. Various embodiments are also directed to non-transitory machine, e.g., computer, readable medium, e.g., ROM, RAM, CDs, hard discs, etc., which include machine readable instructions for controlling a machine, e.g., processor to implement one, more or all of the steps of the described method or methods.

Numerous additional variations on the methods and apparatus of the various embodiments described above will be apparent to those skilled in the art in view of the above description. Such variations are to be considered within the scope of the current disclosure.

What is claimed is:

1. A parking meter comprising:
a parking meter mechanism having a base; and
an extruded tubular base secured to an existing pole at a parking meter location, the extruded tubular base extending from adjacent the ground to the base of the parking meter mechanism, wherein the parking meter mechanism is secured to the extruded tubular base.

2. The parking meter of claim 1, wherein the extruded tubular base encloses a coin canister.

3. The parking meter of claim 2, wherein the coin canister is accessed through an opening in the base of the parking meter mechanism.

4. The parking meter of claim 3, wherein the parking meter mechanism is moveable between a maintenance position in which the opening is exposed to allow access to the coin canister and an operating position in which the opening is covered.

5. The parking meter of claim 2, wherein the coin canister is accessed through a door opening in the extruded tubular base.

6. The parking meter of claim 5, wherein a lockable door secures access to the coin canister through the opening in the extruded tubular base.

7. The parking meter of claim 6, wherein the lockable door is secured to a frame structure secured within an interior of the extruded tubular base.

8. The parking meter of claim 7, wherein the frame structure comprises a pair of channels that engage with edges of the door opening in the extruded tubular base.

9. The parking meter of claim 2, wherein the coin canister is an elongated coin canister.

10. The parking meter of claim 1, wherein the extruded tubular base is secured to the existing pole by an upper ring and a lower ring.

11. The parking meter of claim 10, wherein each of the upper ring and lower ring are secured to both the existing pole and the extruded tubular base.

12. The parking meter of claim 1, wherein a solar panel is provided on at least a portion of an exterior surface of the extruded tubular base.

13. The parking meter of claim 1, wherein an interior volume within the extruded tubular base encloses one or more batteries.

14. The parking meter of claim 13, wherein the one or more batteries comprise rechargeable batteries.

15. The parking meter of claim 13, wherein the one or more batteries are mounted on a battery shelf.

16. The parking meter of claim 1, wherein the extruded tubular structure comprises one more lights.

17. The parking meter of claim 16, wherein the one or more lights comprise one or more light tubes, bubble rods or light strips.

18. The parking meter of claim 16, wherein the one or more lights are arranged down the sides of the extruded tubular structure.

19. The parking meter of claim 16, wherein the lights are controllable to convey information to users or parking enforcement personnel.

20. The parking meter of claim 1, wherein the extruded tubular base displays information or advertisements.

21. The parking meter of claim 1, wherein the extruded tubular base is non-cylindrical.
